(19) United States
(12) Patent Application Publication
(10) Pub. No.: US 2026/0169231 A1
(43) Pub. Date: Jun. 18, 2026

(54) FIBER OPTIC CONNECTOR CONVERSION SYSTEM

(71) Applicant: CommScope Technologies LLC, Claremont, NC (US)

(72) Inventors: Lillian C. KELLY, Bloomington, MN (US); Yu LU, Eden Prairie, MN (US); Levi T. MERRICK, Bloomington, MN (US)

(21) Appl. No.: 19/532,662

(22) Filed: Feb. 6, 2026

Related U.S. Application Data
(63) Continuation of application No. PCT/US2024/042171, filed on Aug. 13, 2024.
(60) Provisional application No. 63/519,297, filed on Aug. 14, 2023.

(51) Int. Cl. G02B 6/38

(52) U.S. Cl. CPC G02B 6/3831; G02B 6/3887

(57) ABSTRACT

The present disclosure relates to enclosures, systems, methods, designs, and assemblies for converting (e.g., modifying, retrofitting, etc.) fiber optic connector cores to be compatible with different connector ports. The present disclosure also relates to connector configurations. The assembly relates to a cable assembly including a cable with an optical fiber and a connector core. The connector core may include a connector core housing, where the optical fiber passes through the connector core housing and is supported at the front end of the connector core housing.

### CROSS-REFERENCE TO RELATED APPLICATIONS

This application is a Continuation of International Patent Application No. PCT/US2024/042171, filed Aug. 13, 2024, which claims the benefit of U.S. Provisional Application No. 63/519,297, filed Aug. 14, 2023, the disclosures of which are incorporated herein by reference in their entireties. To the extent appropriate, a claim of priority is made to each of the above disclosed applications.

### TECHNICAL FIELD

The present disclosure relates to fiber optic data transmission, and more particularly to fiber optic connection systems such as hardened fiber optic connection systems.

### BACKGROUND

Fiber optic communication systems are becoming prevalent in part because service providers want to deliver high bandwidth communication capabilities (e.g., data and voice) to customers. Fiber optic communication systems employ a network of fiber optic cables to transmit large volumes of data and voice signals over relatively long distances. Optical fiber connectors are an important part of most fiber optic communication systems. Fiber optic connectors allow two optical fibers to be quickly optically connected without requiring a splice. Fiber optic connectors can be used to optically interconnect two lengths of optical fiber. Fiber optic connectors can also be used to interconnect lengths of optical fiber to passive and active equipment.

A typical fiber optic connector includes a ferrule assembly supported at a distal end of a connector housing. A spring is used to bias the ferrule assembly in a distal direction relative to the connector housing. The ferrule functions to support an end portion of at least one optical fiber (in the case of a multi-fiber ferrule, the ends of multiple fibers are supported). The ferrule has a distal end face at which a polished end of the optical fiber is located. When two fiber optic connectors are interconnected, the distal end faces of the ferrules abut one another and the ferrules are forced proximally relative to their respective connector housings against the bias of their respective springs. With the fiber optic connectors connected, their respective optical fibers are coaxially aligned such that the end faces of the optical fibers directly oppose one another. In this way, an optical signal can be transmitted from optical fiber to optical fiber through the aligned end faces of the optical fibers. For many fiber optic connector styles, alignment between two fiber optic connectors is provided through the use of an intermediate fiber optic adapter.

Ruggedized (i.e., hardened) fiber optic connection systems include fiber optic connectors and fiber optic adapters suitable for outside environmental use. These types of systems are typically environmentally sealed and include robust fastening arrangements suitable for withstanding relatively large pull loading and side loading. Example ruggedized fiber optic connection systems are disclosed by U.S. Pat. Nos. 7,467,896; 7,744,288 and 8,556,520.

It will be appreciated that a number of different types of ruggedized fiber optic connectors are available for outside environmental use. International Publication No. WO2015/028433 discloses a system for making fiber optic connectors in which a number of different ruggedized outer assemblies having different form-factors or configurations can be selectively mounted on a pre-terminated cable such that the pre-terminated cable can be customized to be compatible with a particular style or type of fiber optic connector or fiber optic adapter. Other systems are disclosed by PCT International Publication Nos. WO2021/041305 and WO2020/236512.

### SUMMARY

Aspects of the present disclosure relate to enclosures, systems, methods, designs, and assemblies for converting (e.g., modifying, retrofitting, etc.) a connector core to a different type of connector.

A fiber optic connector and cable assembly including a cable with an optical fiber and a connector core. The connector core includes a connector core housing having a front end and a back end. The optical fiber passes through the connector core housing and is supported at the front end of the connector core housing. The connector core also includes a ferrule at the front end of the housing. The optical fiber is held in the ferrule. A stop is provided on an exterior surface of the connector core housing. The assembly also includes a converter housing having a front end and a back end. The front end of the converter housing is compatible with a port and the back end of the converter housing has a plurality of converter housing latches that can engage with a stop on the exterior surface of the connector core housing to limit movement of the connector core in a forward direction relative to the connector core housing by engaging with the stop on the exterior surface of the connector core housing. The converter housing latches are ramped such that the converted housing latches can snap over the stop when the converter housing is installed on the connector core housing by inserting the connector housing in a rearward direction over the front end of the connector core housing. The assembly also includes a retainer having a retainer body with a latch containment structure and retainer latches that extend from the latch containment structure. The retainer is mounted on the converter housing and is configured to be carried with the converter housing when the converter housing is inserted over the front end of the connector core housing during installation. The retainer is positionable in a first axial position and a second axial position relative to the converter housing. The converter housing defines first and second axially spaced-apart catch receiving structures corresponding to the first and second axial positions. The first catch receiving structure is rearward with respect to the second catch receiving structure. When the retainer is in the first axial position the latch containment structure is offset from the converter housing latches and catches of the retainer latches are engaged with the first catch receiving structure. When the retainer is in the second axial position the latch containment structure overlaps the converter housing latches to prevent the converter housing latches from flexing outwardly in a radial direction so that the converter housing is locked in place and the catches of the retainer latches are engaged with the second catch receiving structure.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the examples disclosed herein are based.

### BRIEF DESCRIPTION OF THE DRAWINGS

FIG. 1 is a perspective view of a fiber optic connector and cable assembly including a connector core, a converter housing, and a retainer;

FIG. 2 is a perspective view of the converter housing and retainer of FIG. 1;

FIG. 3 is a perspective view of the converter housing of FIG. 1;

FIG. 4 is a second perspective view of the converter housing of FIG. 1;

FIG. 5 is a third perspective view of the converter housing of FIG. 1;

FIG. 6 is a perspective view of the retainer removed from the fiber optic connector and cable assembly of FIG. 1;

FIG. 7 is a second perspective view of the retainer of FIG. 1;

FIG. 8 is a second perspective view of an assembled fiber optic connector and cable assembly of FIG. 1;

FIG. 9 is a perspective view of the fiber optic connector and cable assembly of FIG. 1, with the converter housing, and retainer removed from the fiber optic cable and connector core;

FIG. 10 is a perspective, partial cross-sectional view of the assembly of FIG. 1 with the converter housing and retainer shown being installed on the connector core;

FIG. 11 depicts a rear end of the converter housing;

FIG. 12 is a longitudinal cross-sectional view of the retainer;

FIG. 13 depicts the retainer in a first, non-retaining axial position relative to the converter housing;

FIG. 14 depicts the retainer in a second, retaining axial position relative to the converter housing;

FIG. 15 is another view of the retainer in the second axial position relative to the converter housing;

FIG. 16 is further view of the retainer in the second axial position relative to the converter housing;

FIG. 17 is another view of the retainer in the second axial position relative to the converter housing;

FIG. 18 is a perspective view depicting the converter core of FIG. 1 with an alternative converter configuration including a factory installable converter housing and retainer mounted thereon;

FIG. 19 is a longitudinal cross-sectional view of the assembly of FIG. 18;

FIG. 20 is another longitudinal cross-sectional view of the assembly of FIG. 18;

FIG. 21 is a partial cross-sectional view showing the converter housing and retainer of FIG. 18; the retainer is shown coupled to a strain relief boot;

FIG. 22 is a partial cross-sectional view showing the converter housing and retainer of FIG. 18; the retainer is shown coupled to a shape-memory sleeve (e.g., a heat shrink sleeve that can be shrunk on and bonded to the retainer;

FIG. 23 shows a rotational connection interface between the retainer and the rear end of the converter shroud with the parts aligned but not inserted together;

FIG. 24 shows a rotational connection interface between the retainer and the rear end of the converter shroud with the parts interlocked;

FIG. 25 depicts an example axial and circumferential interlock of the converter housing;

FIG. 26 depicts an example axial and circumferential interlock of the retainer;

FIG. 27 depicts the axial and circumferential interlocks of FIGS. 25 and 26 interlocked;

FIG. 28 depicts the converter core with the strain relief boot of FIG. 21 inserted in a connector port;

FIG. 28A is an exploded view of a portion of FIG. 28 depicting the sealing structure;

FIG. 29 depicts the converter core with the strain relief boot of FIG. 22 inserted in a connector port; and

FIG. 29A is an exploded view of FIG. 29 depicting the circumferential gasket.

### DETAILED DESCRIPTION

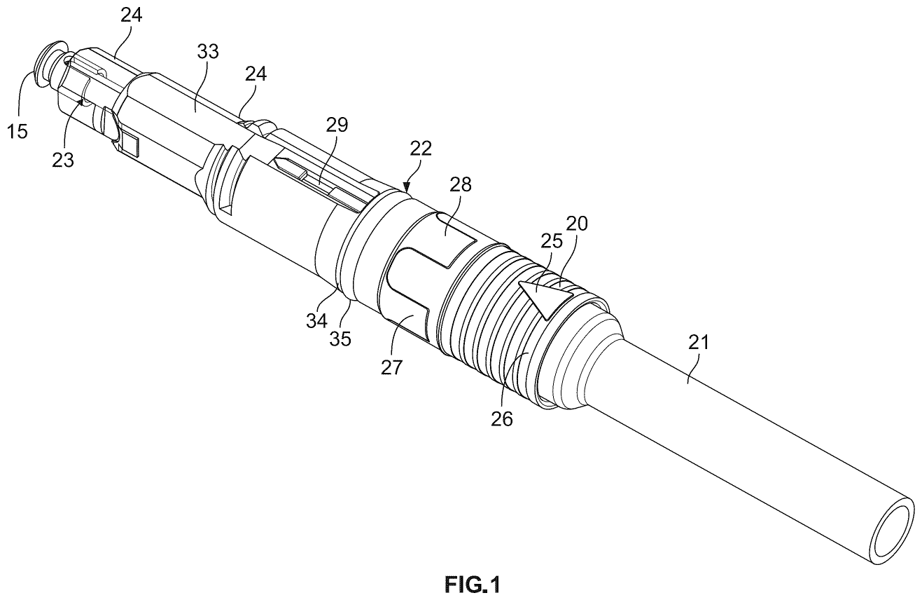

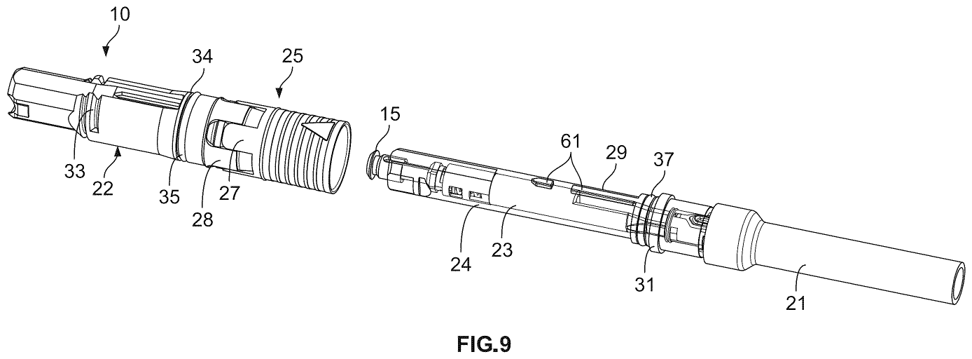

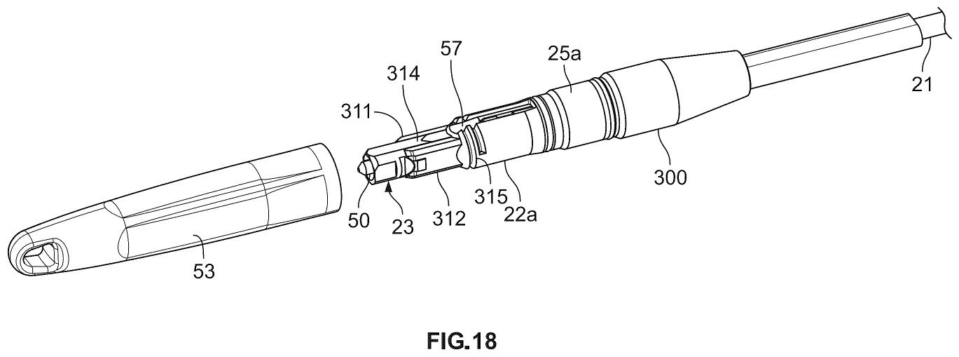

FIG. 1 depicts a fiber optic connector and cable assembly 20 in accordance with the principles of the present disclosure. The fiber optic connector and cable assembly 20 may include a fiber optic cable 21 that is connected (e.g., pre-terminated; factory terminated) to a rear end of a connector core housing 24 of a connector core 23. An optical fiber of the cable 21 may pass through an interior of the connector core housing 24 and is supported at a front end of the connector core housing 24. The connector core 23 may also include a ferrule (shown covered by a dust cap 15 of FIG. 1; an example ferrule 50 and optical fiber 51 are shown at FIGS. 18-20) at the front end of the connector core housing 24, with the optical fiber being held in the ferrule. The connector core housing 24 includes a stop 31 (e.g., a shoulder, flange, etc., see FIG. 9) on an exterior surface of the connector core housing 24. The assembly 20 also is shown including a converter housing 22 that mounts over the connector core 23, and a retainer 25 for securing the converter housing one the connector core 23. In one example, the converter housing 22 and retainer 25 are field installable on the connector core 23 by inserting the converter housing 22 and retainer 25 in a rearward direction over the front end of the connector core and latching the converter housing 22 in place with respect to the connector core via engagement with the stop 31.

The connector core housing 24 may be compatible with a first style of port. In one example, the front of the connector core housing can have a form factor such as an SC connector form factor adapted to be received within an SC fiber optic adapter. The connector core housing 24 can support an exterior radial seal 37 that seals against an inside of the converter housing 22.

The converter housing 22 may have a front end with a form factor compatible with a second style of port and may have a plurality of latches 28 (e.g., converter housing latches) at a rear end of the converter housing 22. In the depicted example, four latches 28 are provided, but the number can be varied. The latches 28 can be cantilever style latches that project rearwardly from a main body of the converter housing and which are circumferentially spaced about a central axis of the converter housing 22. Each of the latches 28 can include a ramp surface 110 and a latching surface 111 integrated adjacent free ends of the cantilever bodies of the latches 28. The latches 28 can be separated in a circumferential orientation by closed ended slots 109. The main body of the converter housing 22 defines first and second catch receiving structures 118, 119 (e.g., sets of first and second grooves) that are axially spaced with respect to each other and accessible through the closed ended slots 109. The first catch receiving structure 118 is rearward with respect to the second catch receiving structure 119. The converter housing 22 may also have an outer circumferential groove 34 for receiving a sealing member such as a radial seal 35 (e.g., a gasket such as an o-ring). The retainer 25 mounts on the converter housing 22 and is preferably carried with the converter housing 22 as the converter housing is inserted over the front end of the connector core 23 during installation. The retainer 25 is mountable in first and second axial positions relative to the converter housing 22. The retainer 25 includes retainer latches 27 (e.g., circumferentially spaced-apart cantilever style latches) adapted to fit in the closed ended slots 109 of the converter housing 22. The latches 27 include positioning catches 120 adapted to engage the first and second catch receiving structures 118, 119. The latches 27 also include locking catches 123 adapted to engage the stop 31 to prevent rearward movement of the retainer 25 relative to the connector core housing 24. The locking catches 123 include locking surfaces 125 adapted to engage a front side of the stop 31, ramp surfaces 127 for allowing the locking catches to ramp over the rear side of the stop 31 when the retainer 25 moved in a forward direction relative to the stop 31. Each ramp surface 127 can function as an abutment surface for abutting against a stop structure 131 of the converter housing 22. The stop structure 131 can be defined at a rear end portion of the converter housing 22 from which the latches 28 rearwardly project. Features of the stop structure are depicted as being angled/ramped and located circumferentially between the latches 28 in axial alignment with the catch receiving structures 118, 119. The stop structure 131 and the ramp surfaces 127 have matching oblique angles relative to a central axis of the converter housing 22. The retainer 25 also includes a latch containment structure 133 (e.g., an annular ring) for inhibiting outward radial movement of the latches 28 of the converter housing 22 when suitably positioned (e.g., when the retainer is in the second axial position). The retainer latches 27 extend axially in a forward direction from the latch containment structure 133 and are located at a front end of the retainer 25.

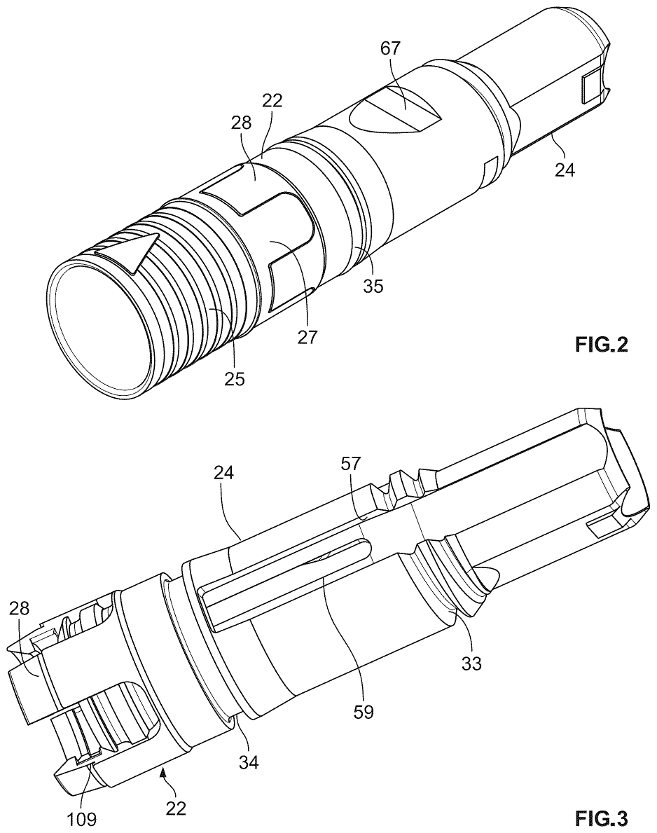

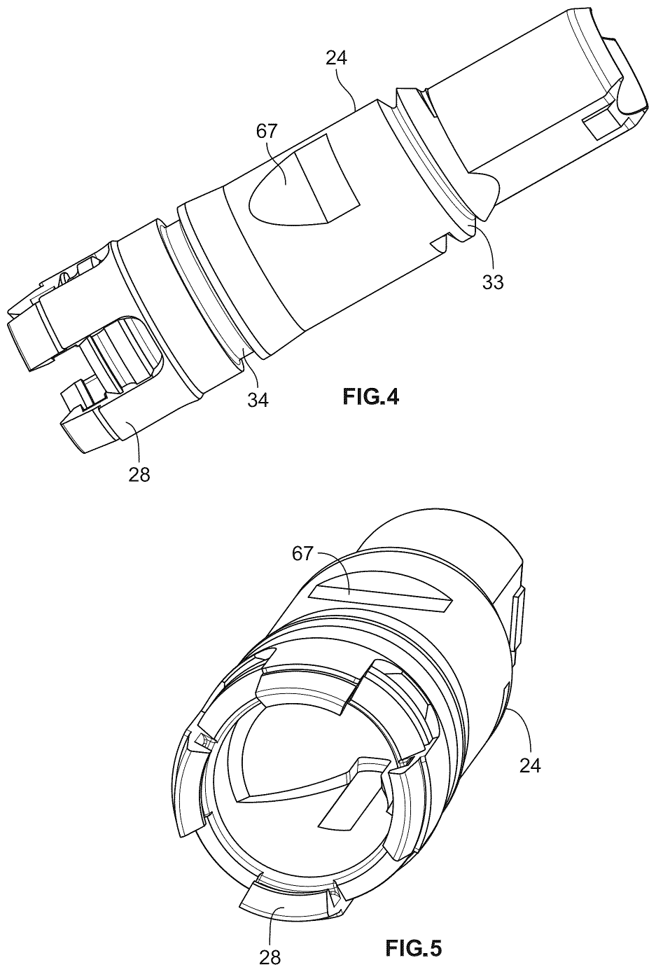

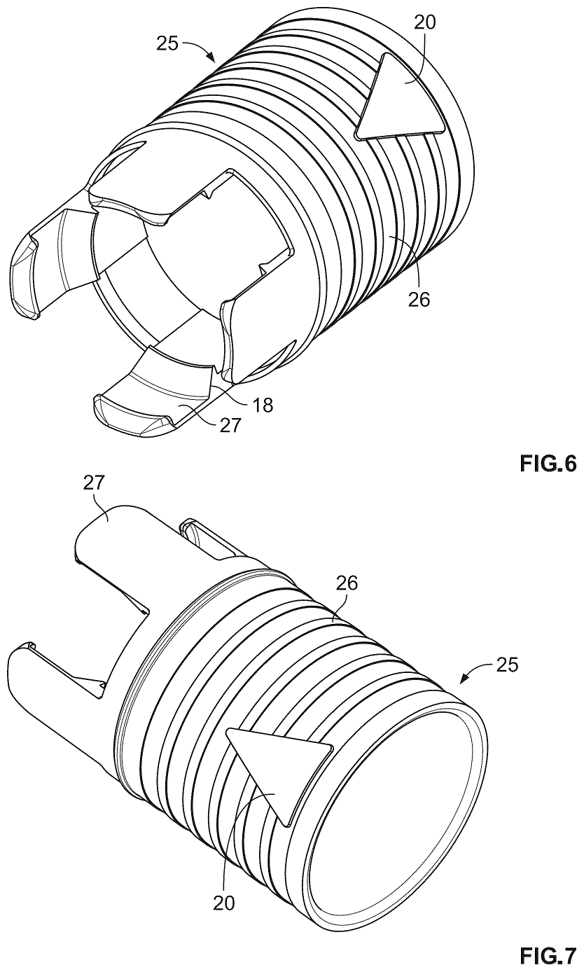

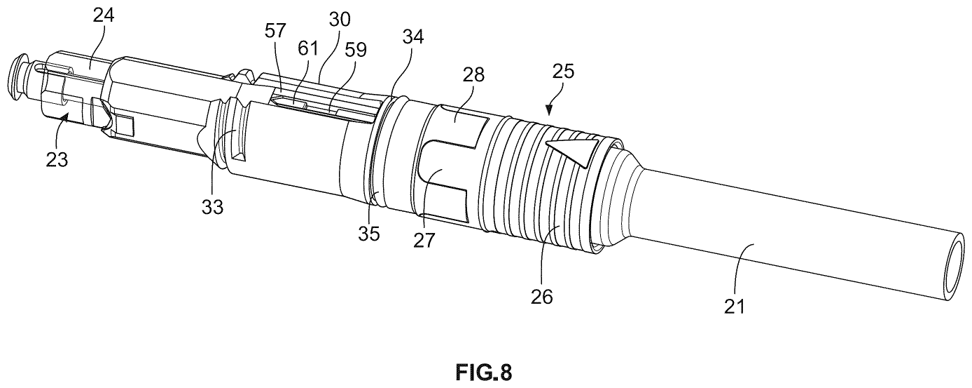

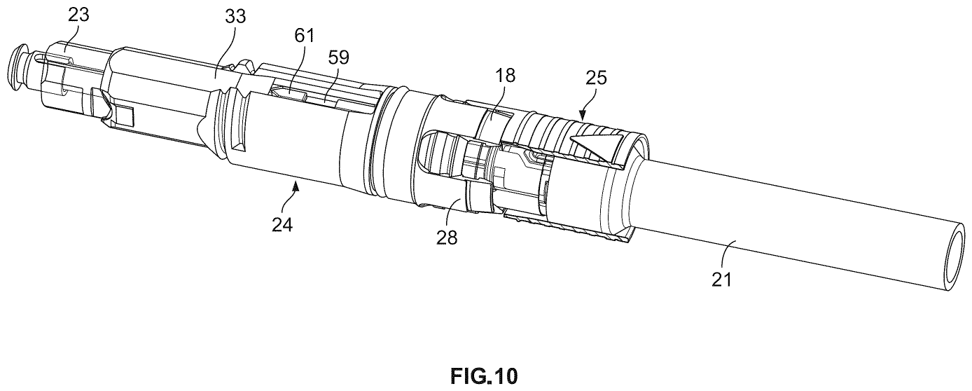

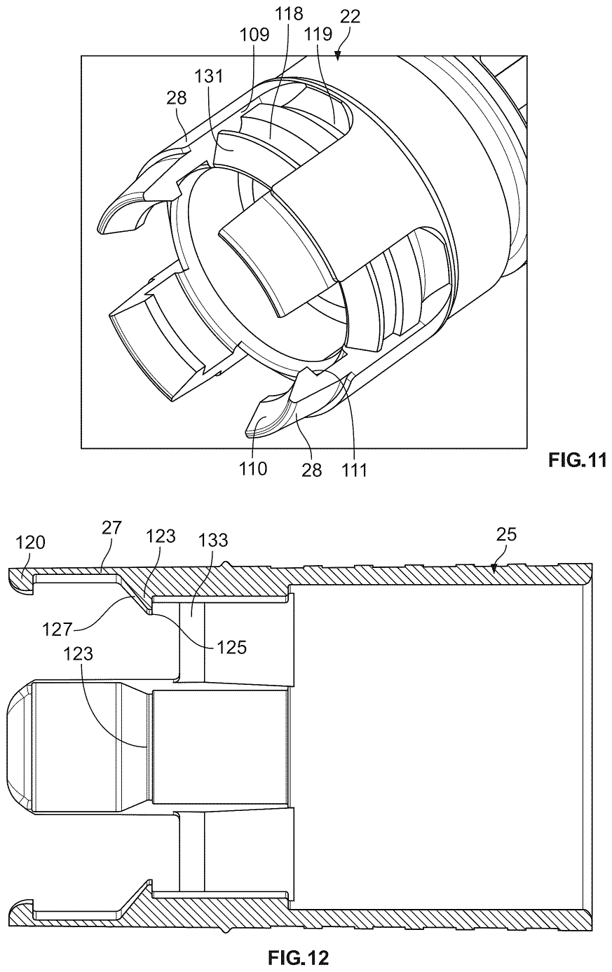

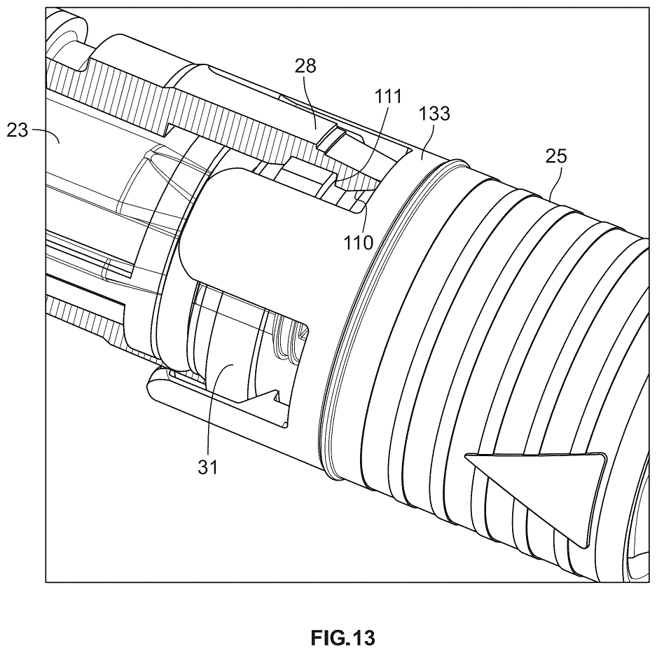

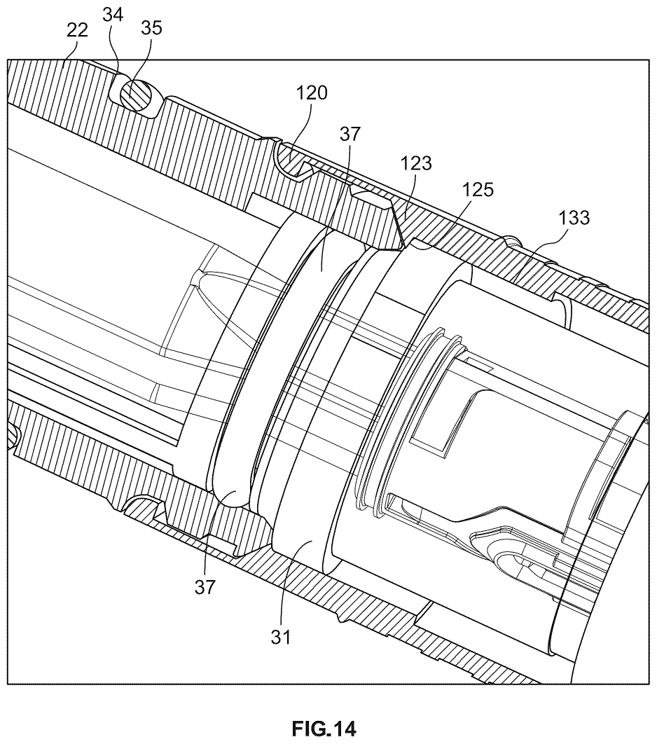

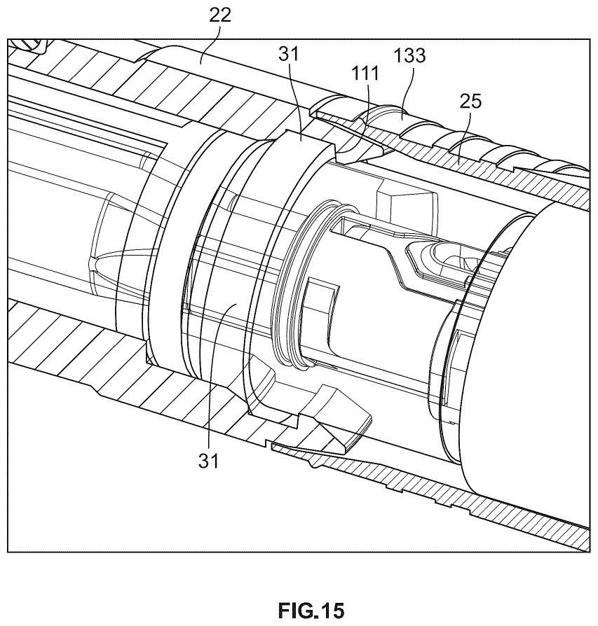

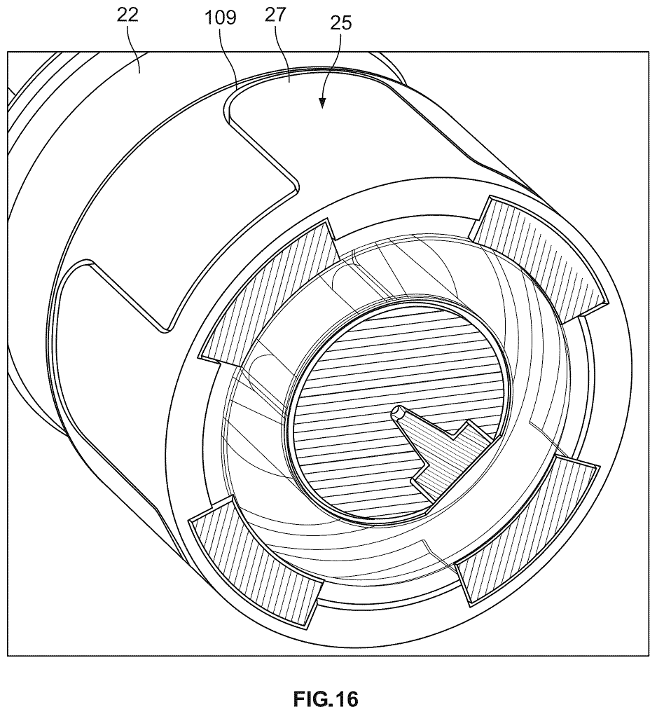

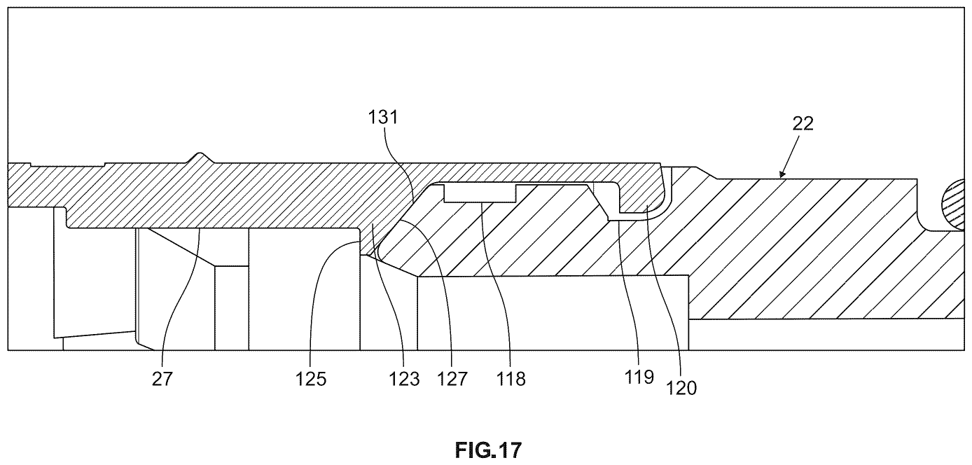

As indicated above, the retainer 25 is positionable in a first axial position (see FIGS. 9, 10 and 13) and a second axial position (see FIGS. 1, 2, 8 and 14-17) relative to the converter housing 22. The first and second axially spaced-apart catch receiving structures 118, 119 of the converter housing 22 correspond to the first and second axial positions. When the retainer 25 is in the first axial position the latch containment structure 133 is rearwardly offset from the converter housing latches 28 and the positioning catches 120 of the retainer latches 27 are engaged with the first catch receiving structure 118. When the retainer 25 is in the second axial position the latch containment structure 133 overlaps the free ends of the converter housing latches 28 to prevent the converter housing latches 28 from flexing outwardly in a radial direction so that the converter housing 22 is locked in place on the connector core 23 and the positioning catches 120 of the retainer latches 27 are engaged with the second catch receiving structure 119. As shown at FIG. 17, the first catch receiving structure 118 can be shallower than the second catch receiving structure 119. When the positioning catches 120 are engaged with the first catch receiving structure 118 the latches 27 can be flexed radially outwardly via contact with the first catch receiving structure 118 to allow the locking catches 123 of the retainer latches 25 to pass over the stop 31 of the connector core 23 during field installation when the converter housing 22 and retainer are inserted as an assembled unit rearwardly over the front end of the connector core 23.

An assembled conversion unit 10 formed by the retainer 25 assembled on the converter housing 22 can be field installed on the pre-terminated connected core 23 by inserting the conversion unit 10 rearwardly over the front end of the pre-terminated connector core 23 until the converter housing latches 28 snap over the stop 31 (e.g., with the assistance of the ramp surfaces 110) so that the latching surfaces 111 oppose the rear side of the stop 31 to prevent forward movement of the unit 10 relative to the core. During rearward insertion, the retainer 25 is in the first axial position relative to the converter housing 22 such that the latches 27 are displaced radially outwardly from the central axis of the converter housing 22 to allow the locking catches 123 to move rearwardly past the stop 31 during rearward insertion of the unit 10. Once the converter housing latches 28 have snapped past the stop 31, the retainer 25 can be moved from the first axial position to the second axial position. In the second axial position, the latch containment structure 133 overlaps (e.g., covers, opposes, etc.) the free ends of the converter housing latches 28 to prevent the converter housing latches 28 from flexing outwardly in a radial direction so that the converter housing 22 is locked in place on the connector core 23. Also, the latches 27 fit within the closed ended slots 109 and the locking surfaces 125 of locking catches 123 oppose the front side of the stop 31 to prevent rearward movement of the retainer 25 relative to the connector core housing 24. The ramp surfaces 127 of the locking catches 123 of the latches 27 allow the locking catches 123 to ramp over the rear side of the stop 31 when the retainer 25 moved in a forward direction relative to the stop 31 as the retainer is moved forwardly from the first axial position to the second axial position. The ramp surfaces 127 of the locking catches 123 abut against the stop structure 131 of the converter housing 22 such that the retainer 25 prevents rearward movement of the converter housing 22 relative to the connector core 23.

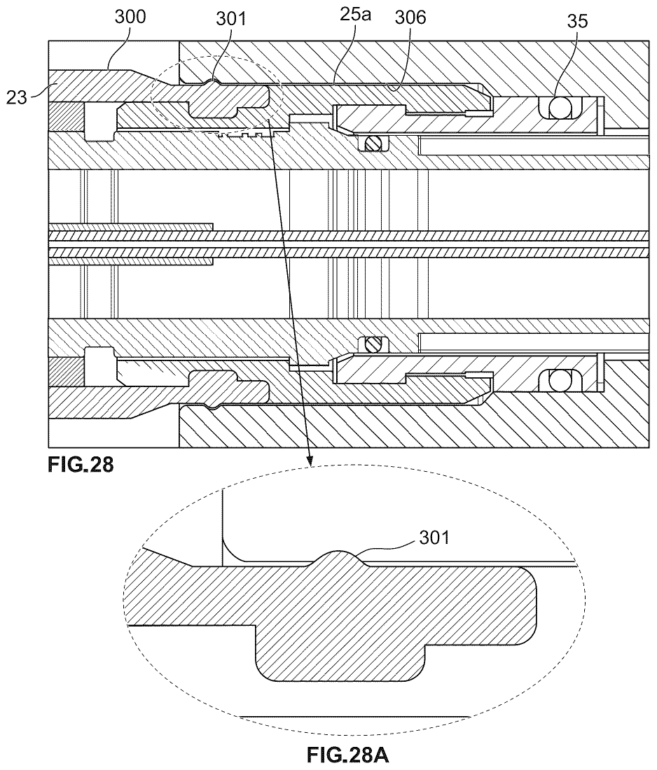

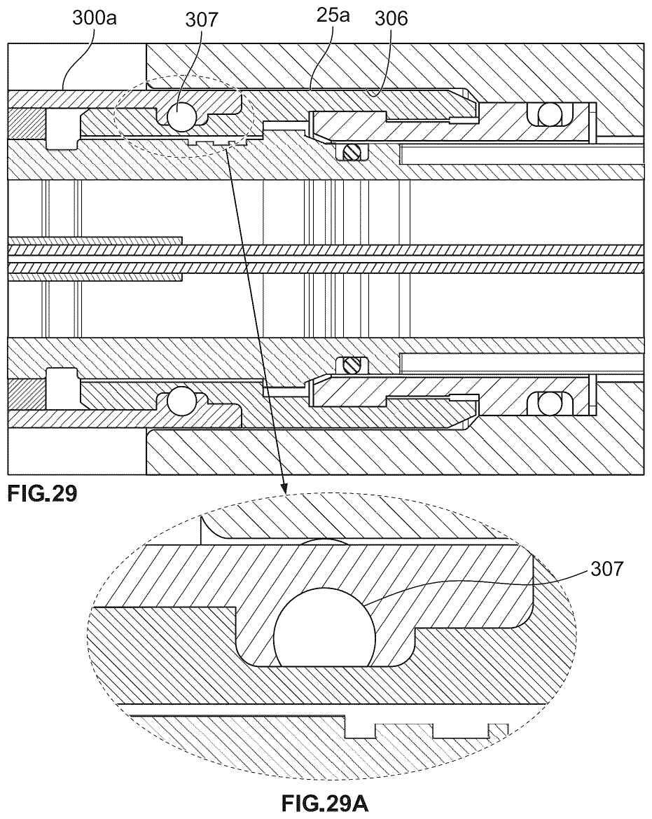

The converter housing 22 can have a front form factor compatible with a connector port (e.g., a connector port defined by a fiber optic adapter) such as connector ports of the type disclosed by U.S. Pat. No. 10,359,577, which is hereby incorporated by reference in its entirety. The converter housing 22 can include an exterior thread 33 positioned forward of the radial seal 35 for mating with an interior thread of a dust cap 53 (see FIG. 18) that fits over the interface end of the converter housing and connector core 23 to secure the dust cap over the converter housing 22. The converter housing 22 includes an exterior notch and shoulder 67 adapted to be engaged by a latch of a connector port when the connector core 23 converted by the converter housing 22 is inserted within the connector port to retain the converted core 23 within the connector port (an example connector port 306 depicted at FIGS. 28 and 29). The converter housing 22 also defines a main longitudinal keying slot 57 that extends generally from the front end of the converter housing 22 to the radial seal 35. The keying slot 57 can be configured for receiving a key of the connector port. The converter housing 22 also includes a secondary longitudinal keying slot 59 positioned within the main longitudinal keying slot 57 for receiving a key 61 (e.g., an external rail that may be a continuous rail or a rail broken into segments) of the connector core housing 24. The secondary keying slot 59 is thinner and shorter than the main keying slot 57 and is defined through a bottom wall of the main keying slot 57. The secondary keying slot 59 is depicted extending completely through the bottom wall of the main keying slot 57 to an interior of the converter housing 22.

On an exterior surface of the retainer 25, there may be ridges 26 that create texture for ease of installation, and as a visual queue of which direction to move the retainer 25 in. On the surface of the ridges 26, there may be an indicator 20 to provide orientation with the body of the retainer 25, and to orient which end connects to the converter body 22. The indicator 20 may be a triangle, or another shape capable of orienting the retainer in relation to the fiber optic connector and cable assembly.

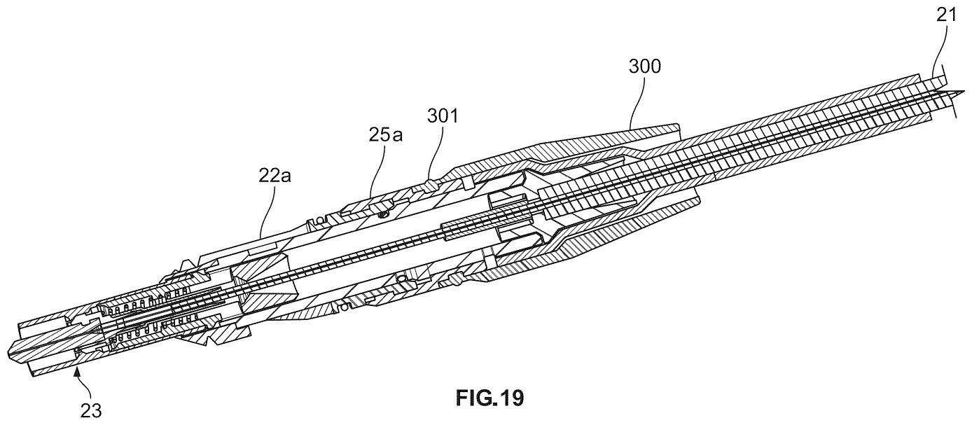

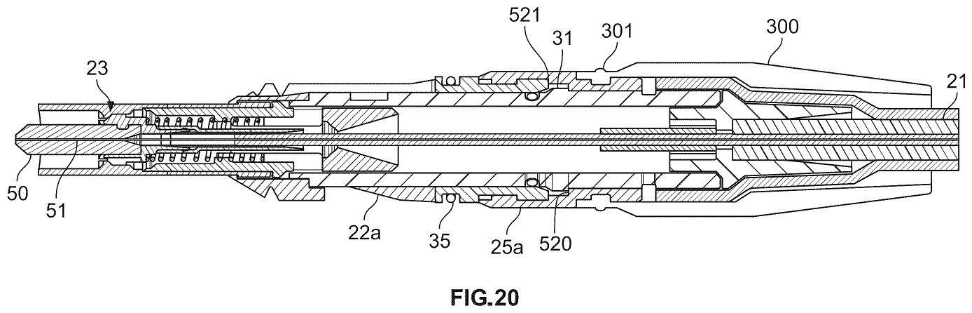

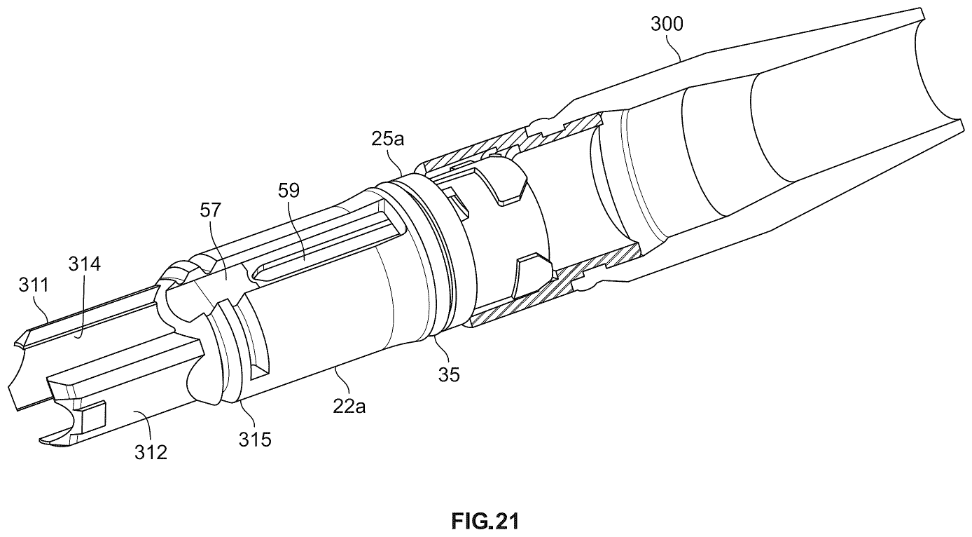

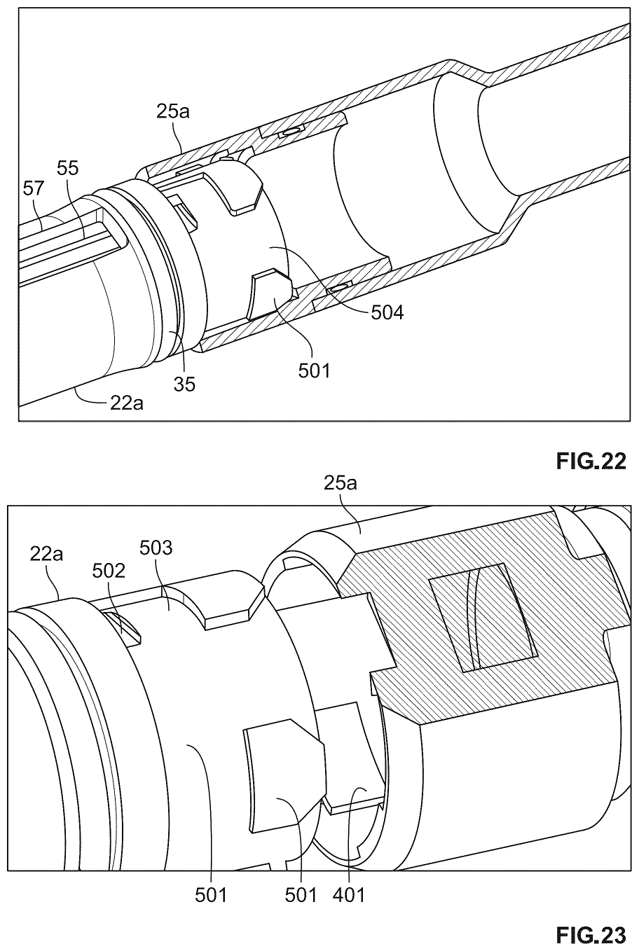

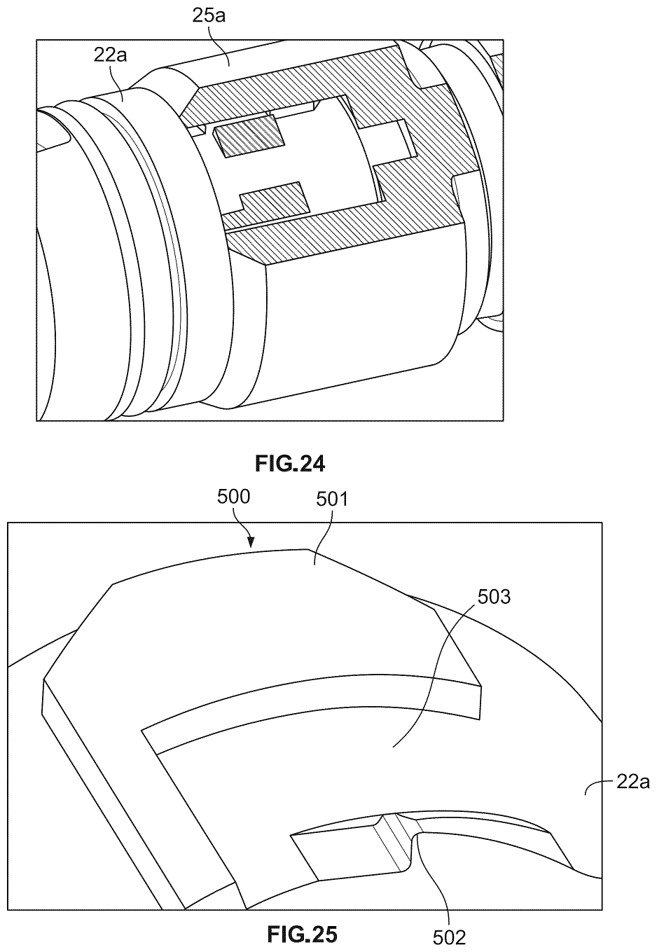

FIGS. 18-29 depict an alternative converter housing 22a and alternative retainer 25a that are adapted to be factory installed on the connector core 23 at the time of termination of the connector core 23 to the fiber optic cable 21. The converter housing 22a and the retainer 25a have been modified to define a rotational, turn-to-engage locking interface for securing the converter housing 22a and the retainer 25a together. The retainer 25a is coupled to a resilient, molded, strain relief boot 300 for providing bend radial protection to the cable 21. The boot 300 includes a unitary outer circumferential sealing structure 301 positioned rearward of the radial seal 35. The sealing structure 301 can be unitary with a main body of the boot 300 and can be a radial projection that circumferentially surrounds the main body of the boot 300. When the converted connector core 23 is inserted into a connector port 306 as depicted at FIG. 28, the radial seal 35 provides a primary radial seal within the connector port 306 and the sealing structure 301 provides a secondary radial seal within the connector port 306. FIG. 29 depicts an alternative configuration where the boot 300 has been replaced by a heat shrink sleeve 300a heat shrunk and bonded over the retainer 25a. A circumferential gasket 307 on the retainer 25a is beneath the heat shrink sleeve 300a and causes an outer circumferential bump in the heat shrink sleeve 300 for providing the secondary radial seal within the connector port 306. The converter housing 22a has also been modified by changing the front end of the converter housing 22a to include first and second projections 311, 312 that are on opposite sides of the converter housing 22a and that are separated by a through-gap 314 that aligns with the main keying slot 57. The projections 311, 312 are parallel and project forwardly from an externally threaded region 315 of the converter housing 22a. When the converter housing 22a and the retainer are installed on the connector core 23, the rear end 521 of the converter housing 22a can abut against the front side of the stop 31 and in inner shoulder 520 of the retainer 25a can abut against the rear side of the stop. When the converter housing 22a and the retainer 25a are secured together, the stop 31 is captured between the rear end of the converter housing 22a and the shoulder of the retainer 25a (see FIGS. 19 and 20). The retainer can be slid over the cable 21 prior to termination of the cable with respect to the connector core 23. After termination, the converter housing 22a can be slid rearwardly over the front of the connector core 23 and the retainer 25a can be slid forwardly over the rear of the connector core 23 to capture the stop 31 between the converter housing 22a and the retainer 25a.

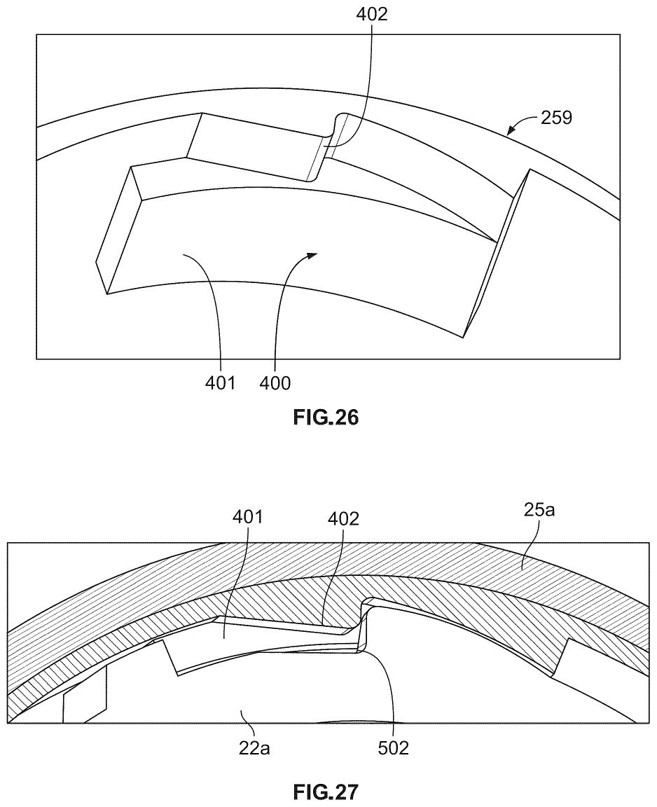

The rotational, turn-to-engage locking interface for securing the converter housing 22a and the retainer 25a together includes a plurality of circumferentially spaced-apart interlock features each including an axial interlock and a circumferential interlock. For example, the retainer 25a includes 4 internal circumferentially spaced apart interlock features 400 each including an axial interlock in the form of a rectangular projection 401 and a circumferential interlock in the form of a ramped catch 402. The ramped catches 402 are located directly at a front end of the retainer 25a and rectangular projections 401 are immediately rearward of the ramped catches 402. As depicted, the rectangular projections 401 are axially aligned with and unitarily formed with the ramped catches 402 (see FIG. 26). The rear end of the converter housing 22a includes 4 external circumferentially spaced apart interlock features 500 each including an axial interlock in the form of a rearwardly tapered projection 501 (e.g., with a tapered lead-in) and a circumferential interlock in the form of a ramped catch 502. The ramped catches 502 are located in front of and axially aligned with the rearwardly tapered projections 501 (see FIG. 25). Pockets 503 for receiving the rectangular projections 401 are defined axially between the ramped catches 502 and the projections 501. Gaps 504 are defined circumferentially between the projections 501 for allowing the projections 401 to pass axially/forwardly between the projections 501 and then rotated a predetermined amount (e.g., 45 degrees) to move into the pockets 503 and be axially captured within the pockets 503 in front of the projections 501. The ramped catches 402, 502 snap together when the projections 401 move into the pockets 502 to secure the retainer 25a in a retaining position with respect to the converter housing 22a with the stop 31 captured axially between the rear end 521 of the converter housing 22a and the inner shoulder 520 of the retainer 25a. The snapped connection between the ramped catches 402, 502 can be permanent or releasable. Once the converter housing 22a has been inserted rearwardly over the front of the core 23, the retainer 25a can be slid forwardly over the core and positioned to axially align the projections 401 with the gaps 504. The retainer is 25a is then moved further forward relative to the converter housing 22a such that the projections 401 move forwardly through the gaps 504. Once the projections 401 pass through the gaps 503, the retainer 25a is rotated a quarter turn to move the projections 401 into the pockets 502 and to engage the ramped catches 402, 502.

From the forgoing detailed description, it will be evident that modifications and variations can be made in the devices of the disclosure without departing from the spirit or scope of the invention.

1. A fiber optic connector and cable assembly comprising:
a cable with an optical fiber;
a connector core including a connector core housing having a front end and a back end, wherein the optical fiber passes through the connector core housing and is supported at the front end of the connector core housing, the connector core also including a ferrule at the front end of the housing, the optical fiber being held in the ferrule;
a stop on an exterior surface of the connector core housing;
a converter housing having a front end and a back end, the front end being compatible with a port and the back end having a plurality of converter housing latches that can engage with a stop on the exterior surface of the connector core housing to limit movement of the connector core housing relative to the converter housing by engaging with the stop on the exterior surface of the connector core housing, the converter housing latches being ramped such that the converter housing latches can snap over the stop when the converter housing is installed on the connector core housing by inserting the connector housing in a rearward direction over the front end of the connector core housing; and
a retainer having a retainer body with a latch containment structure and retainer latches that extend from the latch containment structure, the retainer being mounted on the converter housing and being configured to be carried with the converter housing when the converter housing is inserted over the front end of the connector core housing during installation, the retainer being positionable in a first axial position and a second axial position relative to the converter housing, the converter housing defining first and second axially spaced-apart catch receiving structures corresponding to the first and second axial positions, the first catch receiving structure being rearward with respect to the second catch receiving structure, wherein when the retainer is in the first axial position the latch containment structure is offset from the converter housing latches and catches of the retainer latches are engaged with the first catch receiving structure, and wherein when the retainer is in the second axial position the latch containment structure overlaps the converter housing latches to prevent the converter housing latches from flexing outwardly in a radial direction so that the converter housing is locked in place and the catches of the retainer latches are engaged with the second catch receiving structure.

2. The fiber optic connector and cable assembly of claim 1, wherein the converter housing includes 4 of the converter housing latches and the retainer includes 4 of the retainer latches. further comprising a threaded portion on the converter housing, and a keyed portion on the connector core housing, wherein the threaded portion is configured to engage with the keyed portion and prevent the converter housing from moving up, or down on the cable assembly.

3. The fiber optic connector and cable assembly of claim 1, wherein the first and second catch receiving structures include grooves.

4. The fiber optic connector and cable assembly of claim 1, wherein the retainer latches fit in closed-ended axial slots defined by the converter housing.

5. The fiber optic connector and cable assembly of claim 1, wherein the retainer latches include locking catches having retainer surfaces that engage a front side of the axial stop.

6. The fiber optic connector and cable assembly of claim 1, wherein the converter housing includes a main longitudinal keying slot at an exterior of the converter housing that extends rearwardly from the front end of the converter housing, wherein a secondary longitudinal keying slot is defined fully through a bottom of the main longitudinal keying slot, and wherein a longitudinal key of the connector core fits in the secondary longitudinal keying slot.

7. A fiber optic connector and cable assembly comprising:
a cable with an optical fiber;
a connector core including a connector core housing having a front end and a back end, wherein the optical fiber passes through the connector core housing and is supported at the front end of the connector core housing, the connector core also including a ferrule at the front end of the housing, the optical fiber being held in the ferrule;
a converter housing that mounts over the connector core, the converter housing having a front end and a back end, the front end being compatible with a port, wherein the converter housing includes a main longitudinal keying slot at an exterior of the converter housing that extends rearwardly from the front end of the converter housing, wherein a secondary longitudinal keying slot is defined fully through a bottom of the main longitudinal keying slot, and wherein a longitudinal key of the connector core fits in the secondary longitudinal keying slot.

8. The fiber optic connector and cable assembly of claim 7, wherein the converter housing includes opposing left and right projections at the front end that do not extend forwardly beyond the front end of the connector core when the converter housing is mounted on the connector core, and wherein top and bottom sides of the converter housing are open between the left and right projections.

9. The fiber optic connector core and assembly of claim 7, further comprising a locking interface for securing the converter housing and a retainer together, the locking interface including a plurality of circumferentially space-part interlock features, each including an axial interlock and a circumferential interlock.

10. The fiber optic connector and cable assembly of claim 7, further comprising first and second projections, wherein the projections are on opposite sides of the converter housing and are separated by a through-gap that aligns with the keying slot, and wherein the projections are parallel and project forwardly from an externally threaded region of the converter housing.

11. A fiber optic connector and cable assembly comprising:
a cable with an optical fiber;
a fiber optic connector terminating the cable, the connector including a front end including a ferrule supporting the optical fiber, the connector including a connector housing defining an exterior longitudinal keying slot for receiving a key of a connector port, the fiber optic connector including a first exterior radial sealing member positioned rearward of the keying slot for forming a first radial seal within the connector port, the fiber optic connector also including a second exterior radial sealing member positioned rearwardly with respect to the first exterior radial sealing member for forming a second radial seal within the connector port, wherein the second radial sealing member is unitarily formed with a strain relief boot located at a rear of the connector for providing strain relief to the fiber optic cable.

12. The fiber optic connector and cable assembly of claim 11, further comprising a converter shroud that mounts over a core of the connector, the connector housing being defined by the converter shroud.

13. The fiber optic connector and cable assembly of claim 12, further comprising first and second projections, wherein the projections are on opposite sides of the converter shroud and are separated by a through-gap that aligns with the keying slot, and wherein the projections are parallel and project forwardly from an externally threaded region of the converter shroud.

14. The fiber optic connector and cable assembly of claim 12, wherein the converter housing includes an exterior thread forward of the second radial seal for mating with an interior thread of a dust cap that fits over an interface end of the converter housing and connector core to secure the dust cap over the converter housing.

15. The fiber optic connector and cable assembly of claim 12, further comprising a stop on an exterior surface of the core of the connector, the stop preventing forward movement of the fiber optic connector and cable assembly by engaging with locking catches on a rear side of the stop, and ramp surfaces that act as an abutment surface for abutting against the stop structure of the core.

16. A fiber optic system comprising:
a cable with an optical fiber;
a connector core including a connector core housing having a front end and a back end, wherein the optical fiber passes through the connector core housing and is supported at the front end of the connector core housing, the connector core also including a ferrule at the front end of the housing, the optical fiber being held in the ferrule;
a stop on an exterior surface of the connector core housing;
a component configured to couple with the connector core, the component including a plurality of component latches that can engage with a stop on the exterior surface of the connector core housing to limit movement of the connector core relative to the component by engaging with the stop on the exterior surface of the connector core housing, the component latches being ramped such that the component latches can snap over the stop when the connector core is inserted forwardly into the component; and
a retainer having a retainer body with a latch containment structure and retainer latches that extend from the latch containment structure, the retainer being mounted on the component, the retainer being positionable in a first axial position and a second axial position relative to the component, the component defining first and second axially spaced-apart catch receiving structures corresponding to the first and second axial positions, the first catch receiving structure being rearward with respect to the second catch receiving structure, wherein when the retainer is in the first axial position the latch containment structure is offset from the component latches and catches of the retainer latches are engaged with the first catch receiving structure, and wherein when the retainer is in the second axial position the latch containment structure overlaps the component latches to prevent the component latches from flexing outwardly in a radial direction so that the component and the connector core are locked in place relative to each other and the catches of the retainer latches are engaged with the second catch receiving structure.
